(19) United States
(12) Patent Application Publication
(10) Pub. No.: US 2006/0075220 A1
(43) Pub. Date: Apr. 6, 2006

(54) System and method to authorize a device to receive a content work based on device capabilities and content-work permissions

(76) Inventor: Mark J. Baugher, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 10/956,766

(22) Filed: Oct. 1, 2004

(51) Int. Cl. H04L 9/00

(52) U.S. Cl. 713/156

(57) ABSTRACT

Access to content works, or other information, may be granted based upon device capabilities. A content approving network device, or other device, may make a comparison of a device's components with permissions and then determine if access to a content work is allowed based on the comparison. Methods may include asserting capabilities of a device, comparing the capabilities to permissions, and approving access to content based on the capabilities and permissions comparison.

### BACKGROUND

The recent technology boom, particularly in computing and entertainment systems, has allowed considerable information exchange. Significant economic interests are represented in this information exchange. Due in part to these interests, techniques have been developed to restrict or allow access to information.

One of these techniques involves Digital Rights Management (DRM). DRM technologies encompass methods to authorize a receiver for certain types of access to a content work by a provider. These rights authorize particular types of access such as to render, transfer, or store the content work.

DRM technologies generally need technical protection measures (TPM) on devices to restrict use of the content work to the rights that have been granted to the user of the device. Determined and capable users, however, are practically always able to circumvent TPM, which generally have the modest goal of “keeping honest people honest” rather than preventing any unauthorized access to a content work [Dean S. Marks and Bruce H. Turnbull, “Technical Protection Measures: The Intersection of Technology, Law and Commercial Licenses”, 22 E.I.P.R. 198, 212 (2000)].

As a practical matter, a circumvention device can be used by someone seeking unauthorized access to a content work. For example, DVD movies are protected by a Content Scramble System (CSS). DeCSS (reverse CSS) is a software circumvention device that removes the CSS decryption keys and deciphers encrypted DVD movies on personal computers, which can then be used to store a plaintext movie on a disk or even to transmit it over a network.

Unfortunately, conventional DRM transactions have considerable room for improvement. For example, they require a rights exchange. Also, as stated above, they often require technical protection measures. Furthermore, conventional DRM transactions are quite susceptible to circumvention.

Techniques exist to allow access for a device or user to a content work or to protected information. Ideally, access is granted only if it is favorable to those who restrict access.

The granting of access is an authorization decision. A digital certificate may be used for authorization. Simple Public Key Infrastructure, Simple Distributed Security Infrastructure, KeyNote, and PolicyMaker are all schemes for naming and authorizing principles for the purpose of gaining certain forms of access to some resource.

### BRIEF DESCRIPTION OF THE DRAWINGS

The invention may be best understood by reading the disclosure with reference to the drawings, wherein:

FIG. 1 illustrates a device as may be utilized to process a content work such as a movie or music.

FIG. 2 is a table illustrating a language for describing what kind of device is authorized for a particular content work according to capability types and capability attributes of the device.

FIG. 3 is a flowchart illustrating an example method to practice the present invention.

FIG. 4 illustrates a machine that may contain code that causes the machine to implement aspects of the present invention.

### DETAILED DESCRIPTION OF THE EMBODIMENTS

This discussion discloses specific details for purposes of illustrating embodiments of the invention, however, numerous other arrangements may be devised in accordance with embodiments of the invention. Thus, the embodiments disclosed herein do not limit the invention as set out in the appended claims.

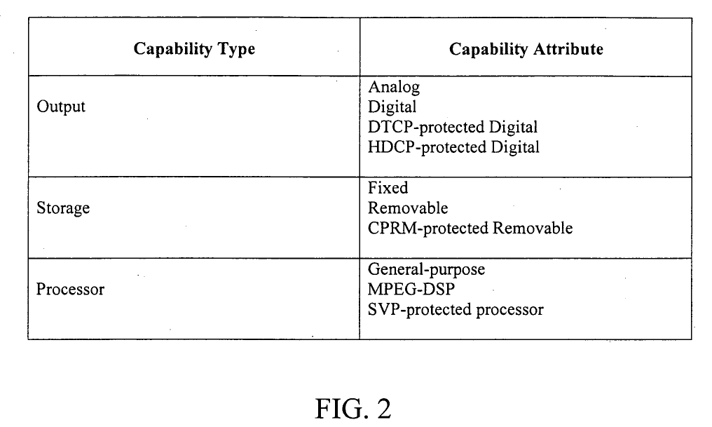

In general, access to a content work, or to information or resources generally, may be granted upon a successful comparison of content-work permissions and capabilities of device components. That is, access may be granted to a device if it has, or lacks, either a certain component or group of components, if the device components favorably match with permissions for the content work. For example, a device and a content work may have an assertion language, a certificate for carrying assertions in the form of certificate attributes, and a query procedure that results in an authorization decision. The assertion language may be based on a model of the device's I/O, storage, and processing capabilities. An example set of assertions is shown in the FIG. 2, as described in detail below.

FIG. 2 represents a table with Capability Type the heading for a first column and Capability Attribute the heading for a second column. Capability Type may include component descriptions such as Output, Storage, or Processor. Capability Attribute may include specific types of each Output, Storage, or Processor. For example, Outputs may include the Capability Attributes of Analog, digital, Digital Transmission Copy Protection (DTCP), and High-bandwidth Digital Copy Protection (HDCP), outputs. DTCP protects devices on Universal Serial Bus (USB) and IEEE 1394 (Firewire) buses. Likewise, Capability Attributes may include specific types of each Storage, such as Fixed, Removable, and Content Protection for Recordable Media (CPRM), where CPRM is a protected storage technology for DVD-writable devices. The Capability Attributes for Processor may include General-Purpose, MPEG-DSP (Motion Picture Experts Group-Digital Signal Processor), and SVP (Secure Video Processor) technology for protecting video on general-purpose and special-purpose processors. The table is for example purposes only, more, less, or even different elements may be used in different embodiments.

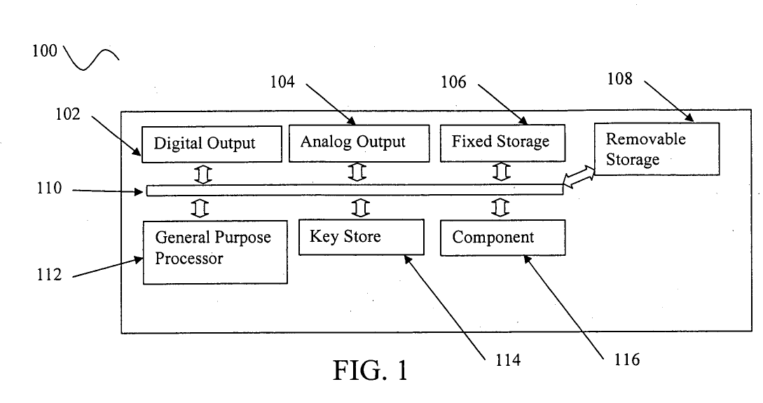

FIG. 1 illustrates a device 100 comprising a plurality of components, as may be utilized in the present invention. FIG. 1 therefore roughly depicts a device comprising the elements of FIG. 2.

Referring to FIG. 1, a device may comprise a digital output 102, an analog output 104, a fixed storage 106, a removable storage 108, a processor 112, an optional KEY STORE 114, and a generic component 116, each coupled to a bus system 110. The separate components are for illustrative purposes only and other components of equivalent function may be substituted for any of the components. Additionally, the structure of the components all connecting to one bus system is for illustrative purposes only, any structure may utilize the present invention. The processor and I/O devices, moreover, may support content-protection protocols such as DTCP (when the device is a bus), HDCP (when the device is to a high-definition TV or video monitor), or CPRM (when the device is to a writable DVD drive).

For the embodiment in FIG. 1, a comparison for permissions and device 100 components typically occurs outside the device 100 by a third party or other device that determines if the device may have access to a content work. However, the comparison need not be so limited. Generally, any comparator or processing device may make the comparison.

An embodiment may include a comparator that compares the capabilities of device components with permissions of a content work and then determine if access to a content work is allowed based on the comparison. Another embodiment may further comprise an input coupled with at least one of the components, wherein the input can receive a content work. Additionally, another embodiment may further comprise circuitry to determine which components a device comprises. Embodiments may use content-protection techniques such as DTCP and CPRM. The components of a device may include storage, processing, and input/output components.

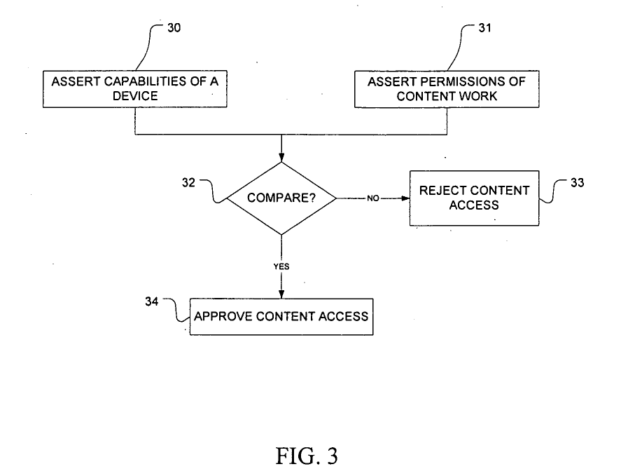

FIG. 3 is a flowchart representing an embodiment method that may practice aspects of the present invention. FIG. 3 is the logic of the comparator that makes an authorization decision based on the capabilities of the device and the permissions of the content work. In block 30 the method involves asserting capabilities of a device. This assertion may be provided, may already exist, or may have to be determined. Likewise, the capabilities may be determined by hardware components of the device, such as I/O, processing, or storage components.

In block 31, the method asserts the permissions of a content work in terms of what kind of device may access it. In an embodiment, the content-work permissions may be expressed in the same language as the device capabilities, such as the language in FIG. 2 and may be contained in a digital certificate that is signed by an authority for the content work. In block 32, the device capabilities are compared to the content-work permissions. In an embodiment, the permissions are in a certificate's attributes in the form of logical predicates (Horn clauses) that can be automatically resolved by a computer. In block 34, access may be approved to content based on the capabilities and permissions comparison. In one embodiment, after access is granted, a content work may be delivered along with a corresponding decryption key over a secure channel. If the two do not compare, the access is rejected at 33.

An embodiment may differ from conventional practices for granting access, for example, rather than granting restricted rights of access to a device capable of exceeding those restrictions, an embodiment of the invention may assume that a device will access content works, or other information or resources, according to device capabilities. This allows an authority to certify the data processing capabilities of an electronic device, such as a device that processes video or audio data.

According to an embodiment, an owner of a content work, which might be a copyrighted movie or song, may then specify the type of device that is permitted to receive a content work according to the device's output, storage and CPU configuration, as an example. An embodiment may devise a language and an algorithm to match device capabilities with content-work permissions and thereby determine whether a device is authorized to receive the content work.

An embodiment of the invention may devise a permissions and capabilities language, for example, one based on first-order logic of assertions and Boolean operatives OR, NOT, AND, SOME and ALL. Such predicates can be structured as Horn clauses and resolved automatically by computer.

It is well known that a predicate calculus can resolve queries against a predicate database of logical assertions. For example, a device capability may be expressed as predicate C, but a content work may have NOT C as a precondition for authorization. In this case, C AND NOT C would resolve to false, and the device would not be authorized to receive the content work and its decryption key.

In an embodiment, these predicates are embodied as attributes in an attribute certificate, which may be digitally signed by a first-party vendor, content provider, service provider, or third-party authority such as a licensing authority, or any other party that may digitally sign a certificate. The predicates may be in the form of Horn clauses with each Horn clause stored as a certificate attribute.

Referring to FIG. 2 in more depth, an analog output might be a ¾ modulator whereas a digital output might support Internet Protocol (IP). Also, for example, the DTCP and HDCP standards may offer an encrypted and authenticated channel on an IEEE 1394 Bus and uncompressed digital video device, respectively.

Referring to the second major row of FIG. 2, STORAGE, a device's hard disk drive(s) may be classified as fixed storage, whereas writable DVD and CD are removable. As stated above, CPRM is a protected storage technology for DVD-writable devices. Any other storage may be utilized in various embodiments of the invention.

The device PROCESSOR is the third Capability Type in FIG. 2. Most devices have processors. PCs and workstations have general-purpose processors, and simple devices use digital signal processors (DSP). SVP is a processor that has protected registers for video decryption. Any generic processing device may be utilized in accordance with aspects of the present invention.

The Capability Type and Capability Attribute columns of FIG. 2 list assertions in the capabilities and permissions language, which consists of sets of first-order predicates. Thus, OUTPUT is an assertion that the device contains one or more output interfaces whereas NO OUTPUT is an assertion that the device contains no outputs (logically, this is NOT OUTPUT and NO is syntactic sugar for NOT). If the language is applied to a content work, however, OUTPUT specifies that the work is authorized for devices that have any type of output interface whereas NO OUTPUT declares that the content work is not authorized for any device that features output interfaces of any sort.

The OUTPUT, STORAGE and PROCESSOR predicates are further modified, defined, or restricted as to their particularities. (OUTPUT ANALOG), for example, is an implicit conjunction declaring that the device contains an analog output. Thus, (OUTPUT ANALOG) AND (PROCESSOR SVP) AND (NO STORAGE) associated with a digital movie, restricts the movie to a device that has only analog outputs and a protected video processor (SVP) with no storage capabilities. A device defined as (OUTPUT ANALOG) AND (PROCESSOR SVP) AND (NO STORAGE) would be authorized for any movie permitted on a device having analog outputs and an SVP but no storage. The predicate form shown here, however, is for expository purposes; the preferred embodiment uses Horn clauses, which are better suited to automated resolution.

These predicates may be conveyed in an authenticated document such as a signed X.509 attribute certificate where each capability or permission predicate is stored in the certificate as an X.509 attribute. Each attribute may form one term of an implicit conjunction with the other attributes (i.e. the attributes are ANDed together).

The process of providing or exchanging certificates is well-known whereby the certificate serves to authenticate the communicating endpoint and provides input into determining if the endpoint is authorized for a certain type of access. In an embodiment, the distributor of a content work must accept the legitimacy of the authority that signs the device certificate as a precondition for continuing authorization tests. Typically, the exchange of certificates will be part of a challenge/response protocol whereby one or more endpoints proves that it is possession of a secret that speaks for the certified entity. The challenge/response protocol may be part of a key-establishment protocol whereby authentication and authorization procedures occur before keys to content works are disseminated to the endpoint. The predicate-attributes of certain embodiments may serve as inputs into the authorization decision.

An embodiment procedure for resolving the content-work and device predicates may first extract the attributes from the content-work certificate and form a predicate database. Each predicate from the device certificate can then be extracted and executed as a query against the predicate database. If each query resolves to true, then the device may be authorized to receive the content work and its decryption key.

In an embodiment, a resolution technique may be the basis for determining authorization of an endpoint. The process of resolving queries against a predicate database is also well known. To illustrate, assume that “A or ˜B” is contained in the device certificate as an attribute. The (non-optimized) query will scan every conjunct among the predicates in the content-work certificate attributes to find either A or ˜B. If neither is found, then the result of that query is false. Since each device predicate (attribute from the device's certificate) is conjoined to every other device predicate, a return value of false makes the final result false since false AND_3 ed onto anything is false. If either A or ˜B is found in the predicate database, that is, if the predicate-attributes are from the content-work certificate, then the next conjunct from the device attributes is fetched and the process is repeated until all queries for each conjunct return true or until any query for a conjunct returns false. The output of the resolution is either true or false, and the output is the authorization decision. This authorization-decision process is of O(N²) complexity, but there are techniques to optimize this process when N is large. Access may be granted on either a true or false resolution, depending on the embodiment. Access implies that the device may receive the content work and securely receive the key to decipher that content work.

In constructing a predicate database, an embodiment may prohibit a capability unless it is explicitly permitted. In the previous permissions example, (OUTPUT ANALOG)) AND (PROCESSOR SVP) AND (NO STORAGE) is functionally identical to (OUTPUT ANALOG)) AND (PROCESSOR SVP), which does not mention storage and therefore forbids it. The predicate (STORAGE), however, permits any type of storage device; so too for (OUTPUT) and (PROCESSOR).

An embodiment may thereby support and restrict the addition of new capability attributes that will likely emerge through innovation in device architectures. Thus, if a new type of encrypted and authenticated storage technology called SAFTDISC is invented, for example, a new SAFTDISC capability could be added to the STORAGE row of FIG. 2.

Also, specialized capability attributes may be added to further restrict an attribute, such as the name of a particular model or maker of the device attribute, e.g. (STORAGE CPRM) AND (MODEL DISKCO-CPRM-MODEL-9) identifies the CPRM component as being made by a company named DiskCo and labeled CPRM-MODEL-9. Attribute types may also be added in the future when new classes of device capabilities are invented.

In an embodiment, a language can be devised to express both (1) the data-processing capabilities of a device and (2) the type of device that is authorized to receive a particular content work. An embodiment of the invention may include an algorithm for determining whether a device, with a given data-processing capability, is authorized to receive a content-work with a given set of permissions, which declare the authorization requirements in terms of device capabilities.

In a conventional DRM transaction, rights must be requested by and then conferred to a user when a content work is transferred to the user's device. The target device frequently requires technical protection measures to ensure that access to the content work does not exceed the rights that have been conferred. An embodiment of the invention may avoid this complexity by assuming that a device will access a content work to the full extent of its capabilities to copy the work on its output interfaces, store the work on its disks, or to process the work for rendering or other types of access. This is a simpler and less complex strategy that exploits the special purpose nature of inexpensive media appliances and eliminates the need for technical protection measures and rights negotiation. The former are practically always circumvented and the latter has not proven compelling to content providers or consumers in the marketplace.

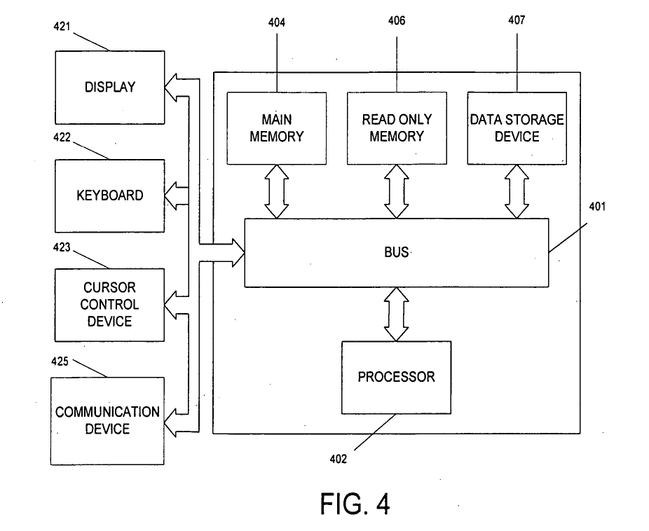

FIG. 4 is a block diagram of an exemplary device as may be utilized in embodiments of the invention. Embodiments of the invention are not limited to a single computing environment. Moreover, the architecture and functionality of embodiments as taught herein and as would be understood by one skilled in the art is extensible to other types of computing environments and embodiments in keeping with the scope and spirit of the invention. The invention provides for various methods, computer-readable mediums containing computer-executable instructions, and apparatus. With this in mind, the embodiments discussed herein should not be taken as limiting the scope of the invention; rather, the invention contemplates all embodiments as may come within the scope of the appended claims.

Embodiments of the present invention include various operations, which will be described below. The operations, may be performed by hard-wired hardware, or may be embodied in machine-executable instructions that may be used to cause a general purpose or special purpose processor, or logic circuits programmed with the instructions to perform the operations. Alternatively, the operations may be performed by any combination of hard-wired hardware, and software driven hardware.

Embodiments of the present invention may be provided as a computer program product that may include a machine-readable medium, having instructions stored within it, which may be used to program a computer or other programmable devices to perform a series of operations according to embodiments of the invention. The machine-readable medium may include, but is not limited to, floppy diskettes, optical disks, CD-ROM's, DVD's, magno-optical disks, ROM's, RAM's, EPROM's, EEPROM's, hard drives, magnetic or optical cards, flash memory, or any other medium suitable for storing electronic instructions. Moreover, embodiments of the present invention may also be downloaded as a computer software product, wherein the software may be transferred between programmable devices by data signals in a carrier wave or other propagation medium via a communication link such as a modem or a network connection.

FIG. 4 illustrates an exemplary device 400 upon which embodiments of the invention may be implemented. For example, an apparatus comprising a machine-readable medium may contain instructions that, when executed, cause a machine to assert capabilities of a device, compare the capabilities to permissions, and approve delivery of content based on the capabilities and permissions comparison. An embodiment may include an apparatus further comprising instructions that, when executed, cause a machine to determine capabilities of a device. Another embodiment may include an apparatus further comprising instructions that, when executed, cause a machine to deliver content based on the capabilities and permissions comparison. In an embodiment the capabilities may be hardware capabilities. In an embodiment, instructions may cause a machine to deliver permissions in a certificate. In another embodiment, capabilities may include storage, processing, and input/output capabilities of the device.

In FIG. 4, device 400 comprises a bus or other communication means 401 for communicating information, and a processing means such as processor 402 coupled with bus 401 for processing information. Device 400 further comprises a random access memory (RAM) or other dynamically-generated storage device 404 referred to as main memory, coupled to bus 401 for storing information and instructions to be executed by processor 402. Main memory 404 also may be used for storing temporary variables or other intermediate information during execution of instructions by processor 402. Device 400 also comprises a read only memory (ROM) and/or other static storage device 406 coupled to bus 401 for storing static information and instructions for processor 402.

A data storage device 407 such as a magnetic disk or optical disk and its corresponding drive may also be coupled to device 400 for storing information and instructions. Device 400 can also be coupled via bus 401 to a display device 421, such as a cathode ray tube (CRT) or Liquid Crystal Display (LCD), for displaying information to an end user. Typically, an alphanumeric input device such as a keyboard 422, including alphanumeric and other keys, may be coupled to bus 401 for communicating information and/or command selections to processor 402. Another type of user input device is cursor control 423, such as a mouse, a trackball, or cursor direction keys for communicating direction information and command selections to processor 402 and for controlling cursor movement on display 421.

A communication device 425 is also coupled to bus 401. The communication device 425 may include a modem, a network interface card, or other well-known interface devices, such as those used for coupling to Ethernet, token ring, or other types of physical attachment for purposes of providing a communication link to support a local or wide area network, for example. In this manner, the device 400 may be networked with a number of clients, servers, or other information devices.

It is appreciated that a lesser or more equipped computer system than the example described above may be desirable for certain implementations. Therefore, the configuration of device 400 will vary from implementation to implementation depending upon numerous factors, such as price constraints, performance requirements, technological improvements, and/or other circumstances.

Although a programmed processor, such as processor 402 may perform the operations described herein, in alternative embodiments, the operations may be fully or partially implemented by any programmable or hard coded logic, such as Field Programmable Gate Arrays (FPGAs), TTL logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited operations are performed by a specific combination of hardware components.

What is claimed is:

1. A device, comprising:
components; and
an input coupled with at least one of the components, the input to receive a content work if the components match permissions for the content work.

2. The device of claim 1, wherein a digital certificate, signed by an authority, attests to the capabilities of the components.

3. The device of claim 1, further comprising circuitry to determine which components the device comprises.

4. The device of claim 1, wherein the components include storage, processing, and input/output components.

5. The device of claim 1, wherein the permissions are encoded in a signed digital certificate.

6. A method comprising:
asserting capabilities of a device;
comparing the capabilities to content-work permissions; and
approving access to content based on the capabilities and permissions comparison.

7. The method of claim 6, further comprising determining capabilities of a device.

8. The method of claim 6, further comprising determining the permissions of a content work.

9. The method of claim 6, further comprising delivering content based on the capabilities and permissions comparison.

10. The method of claim 6, wherein the capabilities are hardware capabilities.

11. The method of claim 6, further comprising delivering the permissions in a certificate.

12. The method of claim 6, further comprising delivering the capabilities in a certificate

13. The method of claim 6, wherein capabilities include storage, processing, software and input/output capabilities of the device.

14. A device, comprising:
means for at least one of processing, storing, receiving or sending data; and
means for comparing the at least one of processing, storing, receiving or sending data means with permissions and then determining if access to a content work is allowed based on the comparison.

15. An article of machine-readable media containing instructions that, when executed, cause the machine to:
assert capabilities of a device;
compare the capabilities to permissions; and
approve delivery of content based on the capabilities and permissions comparison.

16. The article of claim 15, the instructions, when executed, further causing the device to determine capabilities of a device.

17. The article of claim 15, the instructions, when executed, further causing the device to deliver content based on the capabilities and permissions comparison.

18. The article of claim 15, wherein the capabilities are hardware capabilities.

19. The article of claim 15, the instructions further causing the machine to deliver the permissions in a certificate.

20. The article of claim 15, wherein capabilities include storage, processing, software and input/output capabilities of the device.

21. A network device comprising:
a link to send a content work;
circuitry to:
assert capabilities of a remote device;
compare the capabilities to permissions; and
approve delivery of content over the link to a remote device based on the capabilities and permissions comparison.
